(19) United States
(12) Patent Application Publication
(10) Pub. No.: US 2010/0291394 A1
(43) Pub. Date: Nov. 18, 2010

(54) INJECTION MOLDED PLASTIC COMPONENT HAVING AN INSERT

(76) Inventors: Gustav Klett, Moessingen (DE); Martin Schuerer, Aichtal (DE)

Correspondence Address: KENYON & KENYON LLP, ONE BROADWAY, NEW YORK, NY, 10004, US

(21) Appl. No.: 12/308,330

(22) PCT Filed: Oct. 2, 2007
(86) PCT No.: PCT/EP2007/060448

§ 371 Date: Aug. 3, 2010

(30) Foreign Application Priority Data
Oct. 10, 2006 (DE) 10 2006 047 938.6

(51) Int. Cl. B32B 15/09; B32B 15/04; B29C 45/14

(52) U.S. Cl. 428/458; 428/457; 264/261

(57) ABSTRACT

An injection molded plastic component having at least one metallic, at least partially extrusion coated insert. It is provided that the insert has a pre-molded part, at least in the extrusion coated area, whose melting point is lower than or equal to the temperature of the plastic component during injection molding.

### FIELD OF THE INVENTION

The present invention relates to an injection molded plastic component.

### BACKGROUND INFORMATION

There are injection molded plastic components having metallic inserts. They are used, in particular, in electrical and electronic engineering where they occur in a variety of designs as housings or housing components. In many applications there is the requirement that the plastic components, in particular housing components, have inserts leading to the outside, i.e., for example, from the inside of the housing outward, where the inserts are used for fastening or contacting. In general it is required that the inserts should be tightly extrusion coated, i.e., no passage of gases or, in particular, liquids, should be possible between the insert and the plastic component. However, according to the current state of the art, the shrinkage behavior of the plastic and the often complicated geometry of the plastic components prevent the inserts from being extrusion coated in a completely tight manner, in particular because the inserts and the plastic have different temperature coefficients. Also in subsequent process steps, for example in applying further plastic components, for example by laser welding, it must be ensured that the plastic components have no leak paths in the area of the extrusion coated insert.

### SUMMARY OF THE INVENTION

An object of the present invention is therefore to provide plastic components having extrusion coated inserts which do not have the above-cited disadvantages.

For this purpose, an injection molded plastic component having at least one metallic, at least partially extrusion coated insert is proposed. It is provided that the insert has a pre-molded part, at least in the extrusion coated area, whose melting point is lower than or equal to the temperature of the plastic of the plastic component during injection molding. Consequently, a pre-molded part is applied, at least in the area to be extrusion coated when the plastic component is manufactured, which is made of a material whose melting point is selected in such a way that it is lower than or equal to the temperature of the plastic of the plastic component during injection molding. Hereby, the surface of the pre-molded part which is applied to the insert fuses during extrusion coating with the plastic, whereby a much better, more intimate bond is obtained between the insert and the plastic component in the area of the surfaces facing each other. By melting and resolidifying and thus partially fusing the surfaces of the plastic and of the pre-molded part, it is ensured that the plastic encloses the insert absolutely tightly, without any leak paths. The problems known from the related art occurring during the injection molding operation due to the different shrinkage characteristics or thermal expansion characteristics are therefore almost negligible.

In another specific embodiment, it is provided that the pre-molded part is a plastic injection molded part. By selecting a plastic injection molded part as the pre-molded part, a largely uniform thermal behavior of the pre-molded part and the plastic during the injection molding of the plastic component may be ensured. In particular, it may be determined, via the selection of the material of the plastic injection molded part, to what degree the pre-molded part is fused during injection molding of the plastic component, i.e., how strong the bond between the pre-molded part and the plastic of the plastic component should be in the extrusion coated area. In another specific embodiment, it is provided that the pre-molded part is a molding. A highly intimate bond of the pre-molded part with the plastic during the extrusion coating of the extrusion coated area may in turn be ensured by the design of the pre-molded part as a molding, which has a particularly suitable shape for particular sealing, selected according to the particular application, for example peripheral rings or lips. It is critical here that the shaping takes into account the flow characteristics of the hot plastic during injection molding, so that a possibly complete enclosure of the pre-molded part with the hot plastic is reliably ensured.

In one specific embodiment of the present invention, the insert is an electrical conductor. Specifically, in the application of housing penetrations used for contacting electrical circuits, situated toward the outside in a plastic housing, these components may be used to particular advantage because a particularly effective sealing of the inside of the housing toward the environment is required here, while contacting of the circuit, located toward the outside in the housing, must be ensured in a simple and cost-effective way. This may be achieved using the present invention.

In a specific embodiment, the electrical conductor is a plug contact. The insert is therefore designed in such a way that it may be directly used for manufacturing plug connections, for example, it having the shape and geometry of the plug contacts commonly used in the related art or their different specific embodiments, for example as knife contacts, at least in one of its sections protruding from the plastic component. Contact, or plug-in strips may be manufactured in a particularly simple way by injecting the plug contacts as inserts.

In another specific embodiment of the present invention, it is provided that the plastic component is designed as a housing component of a housing. The plastic component is therefore manufactured in such a way that it may be used as a housing component, for example as a housing half-shell, and thus it already contains the components passing through the housing component as an insert.

In one specific embodiment of the present invention, the plastic is a fiberglass-reinforced plastic. Plastics having other fillers such as, for example, mica, talcum powder, or carbon fiber, are also considered fiberglass-reinforced plastics here. Fiberglass-reinforced plastics are often used in the manufacture of housings and plug connections because they have extraordinarily favorable properties for these applications. For example, polypropylenes having a fiberglass component may be used here.

In another specific embodiment of the present invention, the plastic is a polybutylene terephthalate. This plastic also has particularly advantageous properties for the above-mentioned applications.

Furthermore, a method for manufacturing an injection molded plastic component having at least one metallic insert at least partially embedded therein is proposed, which is characterized by the following steps:
applying a pre-molded part to at least one area of the insert;
extrusion coating the area of the insert using plastic and subsequently melting or fusing the pre-molded part.

In this embodiment of the method, the above-described intimate bond between the plastic of the plastic component and the metallic insert is ensured during the injection molding operation of the pre-molded part. The pre-molded part may be applied to at least one area of the insert by the conventional methods known from the related art, for example by melting or reverse drawing, depending on the material of the pre-molded part.

Further advantageous specific embodiments result from the descriptions herein or from combinations thereof.

The present invention is elucidated below in greater detail with reference to the drawings.

### BRIEF DESCRIPTION OF THE DRAWINGS

FIG. 1 shows an injection molded plastic component having a metallic insert.

FIG. 2 shows the metallic insert having a pre-molded part.

### DETAILED DESCRIPTION

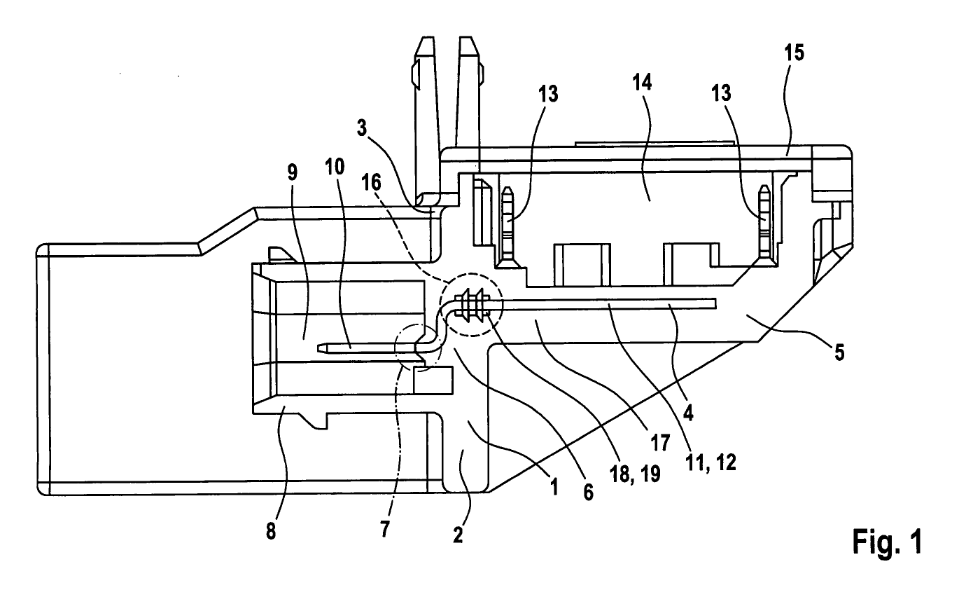

FIG. 1 shows an injection molded plastic component 1, namely a housing component 2 of a plug connector 3. A metallic insert 4 is inserted in a bottom wall 5 and a side wall 6 of plastic component 1, insert 4 being crimped, i.e., bent 90° twice in opposite directions, and passing through side wall 6 of housing component 2 outward in a passage section 7, entering a space 9 located in a plug casing 8, which is in contact with the environment. Plug casing 8 is part of housing component 2. The portion of insert 4 protruding into space 9 is designed as a contact pin 10, the entire insert 4 being an electrical conductor 11, namely a plug contact 12 in particular.

Electrical conductor 11 is connected, in a way not depicted in detail and not relevant to the present invention, to other connectors 13 in a housing interior 14 of a housing 15 formed by housing component 2, usually together with other components. What is essential is a possibly complete, leak-free sealing of housing interior 14 with respect to space 9, i.e., the environment surrounding housing 15 in the area of passage section 7. Passage section 7 continues within side wall 6 as an area 16 extrusion coated by the material of plastic component 1; this is the area in which insert 4 is completely extrusion coated by a plastic 17, from which plastic component 1 is made, during the manufacture of plastic component 1. In extrusion coated area 16, insert 4 is enclosed by a pre-molded part 18. Pre-molded part 18 is designed as a molded plastic component 19.

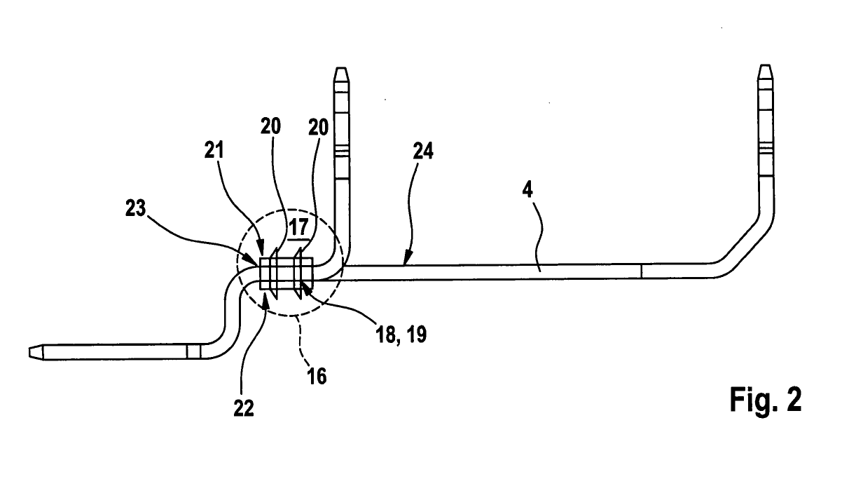

FIG. 2 shows insert 4 of FIG. 1, plastic component 1 being omitted for greater clarity. Pre-molded part 18, namely molded plastic component 19, enclosing insert 4 is mounted in extrusion coated area 16. It has sealing lips 20, which protrude over its peripheral surface 21 and, when extrusion coated with plastic (during the manufacture of plastic component 1), is surrounded by the hot plastic. In particular when molded plastic component 19 is selected from the same or similar plastic as plastic 17, from which plastic component 1 is manufactured, a particularly intimate fusion of the molded plastic component occurs at the moment when hot plastic 17 flows around molded plastic component 19.

Furthermore, by compressing pre-molded part 18 via the plastic introduced into the injection mold under pressure, which is used for manufacturing plastic component 1, a particularly intimate contact between pre-molded part 18 and introduced plastic 17 is obtained. In the area of a pre-molded part outer surface 22, a fusion zone is obtained which, in particular under high pressure of introduced plastic 17 during injection molding, results in an excellent material weld between the material of pre-molded part 18 and introduced plastic 17 of plastic component 1. Due to the fact that pre-molded part 18 is not completely melted, no negative instability occurs in a passage area 23 of the pre-molded part due to heating during injection molding. Passage area 23 is understood as the area in which insert 4 passes through pre-molded part 18, i.e., is in direct contact with a surface 24 on an internal wall 25 of pre-molded part 18. The disadvantageous thermal response of plastic 17 during the injection molding operation, known from the related art, is caused, among other things, by the fact that insert 4 is cold and plastic 17 exhibits a shrinkage when it solidifies after injection molding in the areas in which it is in contact with, i.e., surrounds, surface 24 of insert 4, which results in leakage. Due to the fact that surface 24 is not contacted by hot plastic 17 in the area of pre-molded part 18 during injection molding, no shrinkage occurs at least in this area which would result in leakages at insert 4 due to the different thermal coefficients of insert 4 and plastic 17.

1-9. (canceled)

10. An injection molded plastic component, comprising:
a pre-molded part; and
at least one metallic, at least partially extrusion coated insert, wherein the insert has the pre-molded part, at least in the extrusion coated area, whose melting point is lower than or equal to a temperature of the plastic component during injection molding.

11. The plastic component of claim 10, wherein the pre-molded part is a plastic injection molded part.

12. The plastic component of claim 10, wherein the pre-molded part is a molded plastic component.

13. The plastic component of claim 10, wherein the insert is an electrical conductor.

14. The plastic component of claim 10, wherein the electrical conductor is a plug contact.

15. The plastic component of claim 10, wherein the plastic component is a housing component of a housing.

16. The plastic component of claim 10, wherein the plastic is a fiberglass-reinforced plastic.

17. The plastic component of claim 10, wherein the plastic is a polybutylene terephthalate.

18. A method for manufacturing an injection molded plastic component having at least one metallic insert at least partially embedded therein, the method comprising:
applying a pre-molded part to at least one area of the insert; and
extrusion coating the area of the insert using plastic and subsequently melting or fusing the pre-molded part.
